(19) United States
(12) Patent Application Publication
(10) Pub. No.: US 2024/0097528 A1
(43) Pub. Date: Mar. 21, 2024

(54) GENERATOR OF A WIND TURBINE, STATOR SEGMENT AND STATOR AND ALSO ROTOR SEGMENT AND ROTOR OF A GENERATOR, WIND TURBINE, AND METHOD FOR COOLING A GENERATOR

(71) Applicant: Wobben Properties GmbH, Aurich (DE)

(72) Inventors: Michael Müller, Südbrookmerland (DE); Wilko Gudewer, Norden (DE); Andreas Recktenwald, Saarbrücken (DE); Tobias Muik, Bensheim (DE); Stephan Jöckel, Kleinniedesheim (DE); Manuel Feith, Esens (DE); Wojciech Giengiel, Aurich (DE)

(21) Appl. No.: 18/257,846

(22) PCT Filed: Dec. 17, 2021
(86) PCT No.: PCT/EP2021/086450

§ 371 Date: Jun. 15, 2023

(30) Foreign Application Priority Data
Dec. 18, 2020 (EP) 20215474.6

(51) Int. Cl. H02K 7/18; H02K 1/20; H02K 1/32; H02K 3/24; H02K 15/00

(52) U.S. Cl. CPC H02K 7/183; H02K 1/20; H02K 1/32; H02K 3/24; H02K 15/00

(57) ABSTRACT

A stator segment of a stator of a generator for a wind turbine has at least one stator laminated core which has at least two stator lamination stacks, wherein adjacent stator lamination stacks of the at least two stator lamination stacks are in each case spaced parallel to one another in an axial direction and forming in each case one stator cooling duct with a stator cooling duct width through which a cooling medium can be guided, in particular in a radial direction. A rotor segment of a rotor for a wind turbine has two or a plurality of magnet units are disposed spaced apart from one another in an axial direction, wherein the magnet units disposed adjacently in the axial direction define a circumferential gap with a gap width for feeding and distributing a cooling medium.

### BACKGROUND

### Technical Field

The disclosure relates to a generator of a wind turbine. Furthermore, the disclosure relates to a stator segment of a stator and to a stator of a generator for a wind turbine. Furthermore, the disclosure relates to a rotor segment of a rotor and to a rotor of a generator for a wind turbine. Furthermore, the disclosure relates to a wind turbine. Furthermore, the disclosure relates to a method for cooling a generator.

In particular, the disclosure relates to a segmented generator of a wind turbine. Furthermore, the disclosure relates in particular to a stator segment of a segmented stator and to a segmented stator of a segmented generator for a wind turbine. Furthermore, the disclosure relates in particular to a rotor segment of a segmented rotor and to a segmented rotor of a segmented generator for a wind turbine. Furthermore, the disclosure particularly relates to a method for cooling a segmented generator.

If reference is made in the description to a generator, a stator and/or a rotor, this preferably includes a segmented generator, a segmented stator and/or a segmented rotor, unless this is expressly excluded.

### Description of the Related Art

A wind turbine is a system that converts kinetic energy from wind into electric energy and feeds it into a power grid. For the conversion of the kinetic energy into electric energy, the wind turbine comprises a generator with a rotor, which is mounted so as to be rotatable about an axis of rotation relative to a stator. Depending on the position of the axis of rotation, a distinction is made between a horizontal and a vertical wind turbine. In the case of the horizontal wind turbine, the axis of rotation is aligned horizontally. In the case of the vertical wind turbine, the axis of rotation is aligned vertically. Horizontal wind turbines are also known as horizontal axis wind turbines and vertical wind turbines are also known as vertical axis wind turbines.

Modern wind turbines generally concern so-called horizontal-axis wind turbines, in the case of which the axis of rotation is disposed substantially horizontally and the rotor blades sweep through a substantially vertical rotor area. Furthermore, wind turbines have a nacelle which is disposed on a tower of the wind turbine so that it can rotate about a substantially vertical axis.

When the wind turbine is in an operating state, the wind causes the rotor blades to rotate, which drive the rotor of a generator which is coupled to the rotor blades. In the operating condition, the rotor blades and the rotor rotate relative to a stator of the generator. Due to the relative movement between rotor and stator, the (electric) generator generates electric energy. In the operating state of the wind turbine, the wind turbine is constructed at the installation site and is operated to convert the kinetic energy of the wind into electric energy.

Wind turbines can be embodied without a gear or with a gear. In particular, gearless wind turbines have generators with a large diameter. It is quite common for the generators to have a diameter of 5 m and more. These generators can be embodied as so-called internal rotors or as so-called external rotors. In the case of an internal rotor, the rotor of the generator rotating conjointly with the rotor blades is disposed inside a stationary stator of the generator. In the case of an external rotor, the rotor is disposed outside of the stator. In the case of the external rotor, the stator is in particular disposed inside the rotor, preferably so as to be radially inside in terms of the rotor. Irrespective of the type of generator, generators are usually fastened to the nacelle, in particular a machine carrier, of the wind turbine.

Wind turbines, in particular their generators, must be cooled with a cooling medium. In particular, the stator and the rotor of a generator are to be cooled with the cooling medium. It is known to cool a generator with air as a cooling medium, in particular with a generated stream of air. For this purpose, the air for cooling must be distributed in particular between the rotor and the stator.

So that the generator achieves a high output, the rotor and the stator are to be disposed at a spacing from one another, with an air gap that is as small as possible. If the generator is configured as an external rotor, the air gap extends between a rotor internal circumferential face of the rotor and a stator external circumferential face of the stator. Usually, the air gap extends annularly in a circumferential direction, orthogonal to the axis of rotation, between the stator and the rotor. If the generator is configured as an internal rotor, the air gap extends between a stator internal circumferential face and a rotor external circumferential face. In an axial direction parallel to the axis of rotation, the rotor and/or the stator can extend by 1 m and more. To this extent, the air gap between the rotor and stator can also have an extent of 1 m or more in the axial direction. It is also conceivable for the rotor and/or the stator to extend in the axial direction parallel to the axis of rotation by 1 m and less, and in this respect the air gap between the rotor and stator also has an extent of 1 m or less in the axial direction.

In order to achieve the highest possible output with the generator, a narrow air gap is required. However, as the air gap narrows, it becomes increasingly difficult to distribute air between the stator and the rotor to cool the generator. This is because if the air gap narrows, the flow resistance between the rotor and the stator increases. It is therefore known to convey the air at a high pressure into the air gap between the rotor and the stator, or to convey said air out of the air gap between the rotor and the stator at a high negative pressure. However, large ventilators or the like are required for this in order to generate the desired air flow for cooling. On the one hand, this is expensive and maintenance-intensive and, on the other hand, runs counter to a compact construction of a generator. In the case of permanently excited generators in particular, cooling is essential in order to maintain the operating state of the generator or the wind turbine and to prevent coils from being damaged. This is because if the temperature inside the generator rises above a certain temperature, the performance of the generator decreases and, in the worst case, leads to an irreversible (partial) demagnetization of the permanent magnets, i.e., the efficiency of the generator will be irreversibly, i.e., permanently, minimized. In particular, when the air gap extends over a large width in the axial direction, uniform cooling of the stator and the rotor in the axial direction becomes difficult or even impossible. Rather, the cooling effect decreases in the axial direction.

The European Patent Office has searched the following prior art in the priority application for the present application: EP 3 351 791 A1, US 2010/102656 A1, CN 110 445 307 A, US 2020/373812 A1, US 2007/024129 A1, WO 2014/054830 A1, EP 1 710 432 A1.

### BRIEF SUMMARY

Some embodiments provide a generator of a wind turbine, a stator segment, a stator, a rotor segment, a rotor, a wind turbine and a method for cooling a generator, which eliminate or reduce one or more of the disadvantages mentioned. In particular, some embodiments provide a solution that enables a more powerful generator, or a more powerful wind turbine, with more cost-effective cooling.

Some embodiments include a generator for a wind turbine.

Unless expressly stated otherwise, indications pertaining to the axial direction, the circumferential direction and the radial direction in the description are to be understood in terms of the axis of rotation of the generator. The axial direction corresponds to a direction parallel, i.e., along the axis of rotation. The circumferential direction corresponds to a direction substantially tangential or parallel to the axis of rotation. The radial direction corresponds to a direction radial to the axis of rotation.

The generator is preferably configured as a segmented generator. However, it can also be preferable for the generator to be configured as a non-segmented generator. In particular, a generator configured as a non-segmented generator comprises a single generator segment, in particular a single rotor segment and a single stator segment, which each extend through 360° in the circumferential direction.

The segmented generator for a wind turbine comprises two or a plurality of generator segments. The two or more generator segments are preferably disposed in an annular manner. In particular, the two or more generator segments are disposed coaxially with an axis of rotation of the segmented generator. In particular, the segmented generator comprises a segmented rotor and a segmented stator. The segmented rotor comprises two or a plurality of rotor segments. The segmented stator includes two or a plurality of stator segments.

The respective generator segment or the respective rotor segment and/or the respective stator segment are preferably configured in a part-annular manner in a circumferential direction in relation to the axis of rotation. In particular, the generator segment or the rotor segment and/or the stator segment have a part-annular geometry. A generator segment or a rotor segment and/or a stator segment, which is correspondingly configured in a part-annular manner or has a part-annular geometry, extends in the circumferential direction with a specific degree of arc between a first and a second separation interface.

The two or more generator segments or the two or more rotor segments and/or two or more stator segments preferably extend with the same degree of arc in the circumferential direction. In particular, the generator segments or the rotor and/or stator segments extend as a function of the number of the respective segments according to the following formula: 360°/(number of segments). According to this, for example, the generator segments of a segmented generator, which comprises two generator segments, extend in the circumferential direction by 180°, with three generator segments it would be 120°, with four generator segments it would be 90° etc. This can apply in an analogous manner to the rotor segments and/or stator segments.

It can also be preferred that the generator segments from which a segmented generator is assembled extend in the circumferential direction with a different degree of arc. For example, a segmented generator can be formed from three generator segments. In such a segmented generator, for example, a first generator segment can extend in the circumferential direction by 180°, a second generator segment by 120° and a third generator segment by 60°. Any other extents in the circumferential direction of the generator segments are conceivable, provided they result in an extension of 360° in the circumferential direction when assembled. The explanations regarding the generator segment can apply in an analogous manner to a rotor segment of a segmented rotor and/or a stator segment of a segmented stator.

The first and the second separation interfaces extend substantially orthogonally to the circumferential direction. In particular, the first and the second separation interfaces define first and second separation interface planes within which the axis of rotation extends. In particular, the first and/or the second separation interface extend in such a manner that the first and/or the second separating interface plane extend/extends in a radial direction in relation to the axis of rotation. In particular, the first and/or the second separation interface planes, which extend in the radial direction in relation to the axis of rotation, intersect in an axis that is or defines the axis of rotation. In particular, the axis of rotation lies in the first and/or the second separation interface plane, which extend/extends in the radial direction in relation to the axis of rotation.

The first and/or the second separation interface of a generator segment have/has a connecting device. The connecting device at the first and/or the second separation interface is configured to connect to one another adjacent generator segments that are disposed to form a segmented generator. The connecting device of the first and/or the second separation interface is configured in particular to mechanically connect adjacent generator segments. The mechanical connection can be configured as a force-fitting and/or materially integral and/or form-fitting connection. The first and/or the second separation interface preferably has a flange connection and/or a threaded connection as a connecting device for fastening adjacent generator segments in the circumferential direction. The explanations pertaining to the generator segment can apply in an analogous manner to a rotor segment of a segmented rotor and/or a stator segment of a segmented stator.

In particular, it can be preferred that the rotor segment, in particular its magnet carrier segment, extends in the circumferential direction between the first and the second separation interface by way of a segment length, wherein the rotor segment or the magnet carrier segment have/has an external circumferential face with a first separation interface portion with a first length proceeding from the first separation interface in the circumferential direction toward the second separation interface; and a second separation interface portion having a second length from the second separation interface in the circumferential direction toward the first separation interface; and a connecting portion having a third length extending between the first and the second separation interfaces; wherein a reinforcement device for reinforcing the magnet carrier segment is disposed in the region of the first and the second separation interface portion on the circumferential face of the rotor. In addition or as an alternative, it can be preferred that the rotor segment has a reinforcing ring segment and/or a reinforcing disk.

In addition or as an alternative, it is also preferred that the segmented generator is configured as a permanently excited segmented generator. In this preferred embodiment it is provided that one or a plurality of permanent magnets are disposed on the rotor. A permanent magnet, also known as a permanently excited magnet, is a magnet that has a constant magnetic field that is not generated by electric power, as is the case with electromagnets. The permanent magnet is composed of a magnetized material. Examples of magnetized materials of a permanent magnet are alloys of iron, cobalt, nickel, etc.

The segmented generator is preferably configured as an external rotor. In the case of a segmented generator configured as an external rotor, the stator or segmented stator in the radial direction, in terms of the axis of rotation, is located on the inside in relation to the rotor, or the segmented rotor. In the case of a segmented generator configured as an external rotor, its segmented rotor lying radially on the outside usually encloses the segmented stator lying radially on the inside.

In the operating state of the wind turbine, the segmented generator is fastened in particular to a bearing unit. The bearing unit has a stationary bearing part and a rotating or rotatable bearing part. The rotatable bearing part by means of bearing elements, for example ball bearings, roller bearings, barrel bearings or the like, is rotatably mounted relative to the stationary bearing part about the axis of rotation. In the operating state, the segmented stator is fastened to the stationary bearing part. In the operating state, the segmented rotor is fastened to the rotatable bearing part. In order to fasten the stator, the bearing unit preferably has a stator main body flange on the stationary bearing part. In order to fasten the rotor, the bearing unit preferably has a rotor main body flange on the rotatable bearing part. It is to be understood that the flange surface of the stator main body flange and the rotor main body flange are disposed at a spacing, in particular the axial spacing, from one another.

With the segmented construction mode of the generator, transport-related size restrictions of a generator can be overcome. In particular, segmented generators can also be transported to installation sites of wind turbines that are difficult to access and assembled on the tower of the wind turbines on the nacelle by transporting the generator segments individually. In particular, no large and expensive special cranes are required for the assembly of a segmented generator. Rather, the generator segments can be positioned individually on the nacelle or the machine carrier with a small crane, which only has to carry the mass of a single generator segment and reach the assembly height. This saves costs that would otherwise be incurred for the much more expensive large cranes. Furthermore, such large cranes are generally only available to a limited extent, so that the segmented generator offers more flexibility with regard to the assembly time and also the assembly site.

The rotor and the stator are spaced from one another in the radial direction by an air gap. In particular, the air gap extends between a rotor internal circumferential face and a stator external circumferential face. In particular, a magnet unit of the rotor forms the rotor internal circumferential face, and a stator laminated core and/or coil units disposed thereon form/forms a stator external circumferential face.

The air gap extends in the axial direction by way of an air gap width, and in the circumferential direction by way of an air gap length. In particular, the air gap in the axial direction extends across a width of the stator and/or the rotor. In particular, the air gap in the axial direction extends across the width of the active parts of the stator and/or the rotor. The active parts of the rotor comprise, in particular, the magnet units fastened to a rotor laminated core and/or a magnet carrier segment. The active parts of the stator preferably comprise the coil units disposed on a stator laminated core.

In the radial direction, the air gap has a height of at least 5 mm, 10 mm, 15 mm or 20 mm and/or at most 50 mm, 40 mm, 30 mm, 20 mm, 10 mm or 5 mm. In particular, the height of the air gap is essentially 12 mm. In the axial direction, the air gap has a width of at least 100 mm, 200 mm, 300 mm, 400 mm, 500 mm, 600 mm, 700 mm, 800 mm, 900 mm, 1000 mm, 1200 mm, 1400 mm and more and/or maximum 2000 mm, 1800 mm, 1600 mm, 1400 mm, 1200 mm, 1000 mm, 900 mm, 800 mm, 700 mm, 600 mm, 500 mm, 400 mm or less.

In terms of further advantages, design variants and design details of the segmented generator according to the disclosure and its refinements, reference is also made to the following description of the corresponding features and refinements of the stator segment, the stator, the rotor segment, the rotor and the wind turbine and the method for cooling a generator.

Some embodiments include a stator segment of a stator of a generator for a wind turbine. The stator segment is in particular the stator segment of a segmented stator. The stator segment is preferably the stator segment of a segmented generator. It is to be understood that the stator segment is a stator segment for a stator, in particular for a segmented stator. Furthermore, it is to be understood that the stator is a stator for a generator, in particular for a segmented generator.

The stator segment includes a coil carrier segment and at least one stator laminated core. The coil carrier segment has an annular or part-annular geometry and a stator circumferential structure. The stator segment preferably extends in the radial direction between a radially inner flange for fastening the stator segment to a stator main body flange of a bearing unit and a radially outer coil carrier segment. In particular, the stator segment is configured as a shell structure. The stator segment preferably extends in the shape of a truncated pyramid from the flange to the coil carrier segment lying radially on the outside, wherein the cross section of the stator segment increases from the flange to the coil carrier segment lying radially on the outside. In particular, the stator segment forms, preferably integrally, a stator support section which extends from the radially inner flange to the radially outer coil carrier segment.

Furthermore, the at least one stator laminated core preferably has an annular or part-annular geometry. The at least one stator laminated core is configured to receive at least one coil unit and is disposed on the stator circumferential structure. The at least one stator laminated core has at least two stator lamination stacks, wherein adjacent stator lamination stacks of the at least two stator lamination stacks are disposed spaced parallel to one another in an axial direction and forming in each case a stator cooling duct with a stator cooling duct width through which a cooling medium can be guided, in particular in a radial direction.

The stator laminated core preferably comprises at least one stator lamination stack with two or more lamination stack units, which are disposed at a spacing from one another in a circumferential direction. The stator lamination stacks have, in particular, a plurality of first stator lamination elements which are disposed next to one another, in particular stacked, in an axial direction. Furthermore, the at least one stator lamination stack has in particular at least one second stator lamination element, which is different from the first stator lamination element. The at least one second stator lamination element preferably connects adjacent lamination stack units of the two or more lamination stack units to one another. The second stator lamination element has an extent in the circumferential direction that is greater than an extent of the first stator lamination element in the circumferential direction.

The first and the second stator lamination elements have, in the circumferential direction, one or more first portions that extend in the radial direction at a first height and one or more second portions that extend in the radial direction at a second height. The first height is preferably different from the second height. In particular, the second height is smaller than the first height. In particular, the first portion extends in the circumferential direction by way of a first length and the second portion by way of a second length. The first length is preferably different from the second length. In particular, the second length is smaller than the first length. First and second portions disposed alternately in the circumferential direction preferably form a first and/or a second stator lamination element. In particular, a first portion extends in the circumferential direction between two second portions. In particular, a first portion extends in the circumferential direction between two second portions. In particular, the first portion forms a protrusion or stud opposite the second portion in the radial direction, which extends radially outward from the stator internal circumferential face.

It is to be understood that the first and the second stator lamination elements are disposed in such a manner that the two or more lamination stack units of the at least one stator lamination stack have one or a plurality of first portions which extend in the radial direction by way of the first height, and in the circumferential direction by way of the first length; and have one or a plurality of second portions which extend in the radial direction by way of the second height, and in the circumferential direction by way of the second length. In this respect it is also to be understood that the at least one stator lamination stack according to the two or more lamination stack units has at least one first and/or at least one second portion.

The at least one stator laminated core is configured to receive at least one coil unit. In particular, a coil unit is disposed on the stator laminated core in such a manner that a first portion of the stator laminated core extends in the radial direction inside the coil unit. The coil unit is preferably disposed on the stator laminated core in such a manner that the first portion of the stator laminated core extends through the coil unit in the radial direction. In particular, the coil unit is disposed on the stator laminated core in such a manner that it bears on one, in particular on two, second portion(s) of the stator laminated core in the radial direction.

The at least two stator lamination stacks preferably have the same stator lamination stack width in the axial direction. The width of the stator lamination stack is preferably greater than the width of the stator cooling duct. In particular, the width of the stator lamination stack corresponds to at least 110%, 120%, 150%, 200% or 500% of the width of the stator cooling duct. It can also be preferred that the stator lamination stack width corresponds to the stator cooling duct width. Furthermore, it can alternatively be preferred that the width of the stator lamination stack is smaller than the width of the stator cooling duct. In particular, the width of the stator lamination stack corresponds to at least 50%, 60%, 70%, 80% or 90% of the width of the stator cooling duct. In particular, at least one spacer element, which defines the width of the stator cooling duct, is disposed between adjacent stator lamination stacks. The at least one spacer element preferably has an extent in the circumferential direction and/or the radial direction that is smaller than an extent of the first and/or the second lamination element in the circumferential direction and/or radial direction. The height of the stator cooling duct corresponds in particular to the first height of the first portion of the stator laminated core. The length of the stator cooling duct preferably corresponds to the length of the stator laminated core in the circumferential direction. The stator laminated core preferably comprises at least 4, 8, 12, 16, 20, 24, 28, 32 or more stator cooling ducts.

The spaced disposal of the stator lamination stacks in the axial direction has the advantage that cooling of the stator laminated core on the stator external circumferential face by the cooling medium cannot only be effected in the axial direction, but also in the radial direction, quasi within a stator lamination stack. In a particularly advantageous manner, this leads to improved and more uniform cooling of a stator laminated core and, to that extent, of a stator segment or stator of a generator.

The stator segment according to the disclosure and its refinements have features that make it particularly suitable for use for a generator according to the disclosure and/or a wind turbine according to the disclosure and/or a method according to the disclosure and the respective refinements. In terms of further advantages, design variants and design details of the stator segment according to the disclosure and its refinements, reference is also made to the previous description of the corresponding features and refinements of the generator and the following description of the corresponding features and refinements of the wind turbine and the method.

In a preferred embodiment of the stator segment, the stator laminated core comprises a stator guide device for diverting and/or dividing a cooling medium that is fed inward, in particular in the radial direction, in the direction of the stator guide device by way of a stator external circumferential face of the at least one stator laminated core, in particular in the axial direction, wherein preferably the stator guide device has a stator guide device width in the axial direction which is greater than a width of a stator lamination stack of the at least two stator lamination stacks. The stator guide device in the circumferential direction preferably extends by way of the length of the stator laminated core. In particular, the stator guide device has a height in the radial direction that corresponds to the first height of the first portion of the stator laminated core. In particular, the stator guide device by way of the stator laminated cores forms the stator external circumferential face.

It is to be understood that a rotor may have a circumferential gap through which a cooling medium for cooling the stator is provided in the radial direction. In particular, the circumferential gap of the rotor is disposed so as to be co-aligned with the stator guide device, so that the stator guide device divides the cooling medium provided by the circumferential gap, preferably into equal flows of the cooling medium, and diverts said cooling medium outward in the axial direction by way of the stator external circumferential face. A rotor segment having the circumferential gap is described in detail below in the context of the rotor segment. It is preferred that the circumferential gap of the rotor segment has a width in the axial direction that is smaller than the stator guide device width.

This has the advantage that the cooling medium can be fed to the stator laminated core in the axial direction not only from the outside to the inside, but also via the stator guide device in the axial direction from the inside to the outside of the stator external circumferential face and in particular to the stator cooling ducts. In particular, the cooling medium provided centrically in the axial direction can be provided toward the outside for cooling. This improves uniform cooling of the generator. Furthermore, the cooling medium can be conveyed at a lower output while performing an identical cooling output.

According to a further preferred refinement, it is provided that the coil carrier segment has a first and a second carrier plate, between which the coil carrier segment by way of a coil carrier segment width extends in the axial direction, and the stator laminated core has a first and a second pressure sheet, between which the stator laminated core extends by way of a stator laminated core width which is in particular greater than the coil carrier segment width; wherein preferably between the first carrier plate and the second carrier plate are disposed at least two adjacent stacks of stator laminations of the at least two stacks of stator laminations spaced parallel to one another in the axial direction and forming in each case a stator cooling duct through which the cooling medium can be guided, in particular in the radial direction, in particular from a radially outer stator external circumferential face in the direction of a stator internal circumferential face that is radially inside in terms of the stator external circumferential face; and/or between the first carrier plate and the first pressure sheet and/or between the second carrier plate and the second pressure sheet are disposed at least two adjacent stacks of stator laminations of the at least two stacks of stator laminations spaced parallel to one another in the axial direction and forming in each case a stator cooling duct through which the cooling medium can be guided, in particular in the radial direction, in particular from a radially inner stator internal circumferential face in the direction of a stator external circumferential face that is radially outside in terms of the stator internal circumferential face; and/or the stator guide device between two stator lamination stacks of the at least two stator lamination stacks is disposed spaced apart in the axial direction, in particular is in each case disposed spaced apart by the stator cooling duct width; and/or is disposed between the first and the second pressure sheet, in particular so as to be centric.

The stator laminated core in the axial direction by way of the stator laminated core width is preferably wider than the coil carrier segment width of the coil carrier segment. In particular, the stator laminated core is wider than the coil carrier segment in such a manner that disposed between the first carrier plate and the first pressure sheet of the stator laminated core and/or the second carrier plate and the second pressure sheet of the stator laminated core are a plurality of adjacent stator lamination stacks which form a plurality of cooling ducts. Preferably, at least two, three, four, five, six, seven, eight, nine, ten or more stator cooling ducts are disposed between the first carrier plate and the first pressure sheet of the stator laminated core and/or the second carrier plate and the second pressure sheet of the stator laminated core. More stator cooling ducts are preferably disposed between the first and the second carrier plates than between the first pressure sheet of the stator segment and the first carrier plate and/or the second pressure sheet of the stator segment and the second carrier plate.

In particular, a cooling medium flows through the stator cooling ducts disposed between the first pressure sheet and the first carrier plate and/or the second pressure sheet and the second carrier plate in the radial direction, proceeding from the stator internal circumferential face in the direction of the stator external circumferential face and from the stator external circumferential face toward the stator internal circumferential face through the stator cooling ducts located between the first and the second carrier plates.

In this preferred embodiment, the cooling of the generator is improved. In particular, this disposal of the cooling ducts makes it possible that the cooling medium can be guided between the first carrier plate and the first pressure sheet and/or the second carrier plate and the second pressure sheet in the radial direction from the inside to the outside through the at least one cooling duct through the stator laminated core. In particular, the cooling medium for cooling the generator can be supplied in the radial direction through cooling ducts to the air gap formed by the rotor and the stator. This leads to more uniform cooling, increases the efficiency of the generator and reduces the power required to generate a flow of cooling medium.

In particular, the stator guide device is disposed centrically to the stator or stator laminated core in the axial direction. The stator guide device is preferably disposed centrically in the axial direction between the first and the second pressure sheets of the stator laminated core, in particular centrically between the first and the second carrier plates of the stator carrier segment.

This preferred embodiment enables a symmetrical distribution of the cooling medium, which in the radial direction is fed centrically in the direction of the stator external circumferential face, in an axial direction both in the direction of the first and the second pressure sheet of the stator laminated core. This leads to particularly uniform cooling of the stator laminated core or of the stator segment and in particular of the generator.

Furthermore, according to a preferred embodiment, a plurality of stator lamination stacks of the at least two stator lamination stacks are disposed equidistantly between the first and/or the second pressure sheet, in particular between the stator guide device and the first and/or the second pressure sheet.

The equidistant arrangement of the plurality of stator lamination stacks requires, in particular, cooling ducts with an identical width in the axial direction. This particularly promotes the uniform distribution of the cooling medium and in this respect uniform cooling of the stator laminated core, or of the stator segment, and in particular of the generator.

Furthermore, this has the advantage that a stator laminated core with equidistantly spaced lamination stacks can be produced and maintained at low cost. Furthermore, this minimizes the risk that defective parts will be produced during manufacture and also during maintenance due to any confusion in terms of spacings.

According to a further preferred embodiment, the stator segment comprises at least one coil unit, which is disposed on the at least one stator laminated core, wherein the at least one coil unit preferably is composed of or comprises the material copper; and/or wherein coil units that are adjacent in the circumferential direction of the at least one coil unit are disposed with a coil spacing gap, in particular equidistantly from one another; wherein preferably the coil spacing gap between two adjacent coil units of the at least one coil unit is configured as a cooling medium duct through which the cooling medium can be guided, in particular in the radial direction; and/or an insulating element is disposed in the coil spacing gap between two adjacent coil units of the at least one coil unit, said insulating element preferably electrically isolating one coil unit of the at least one coil unit in relation to an adjacent coil unit of the at least one coil unit.

The at least one coil unit is preferably a copper coil. Alternatively, it can also preferably be conceivable that the at least one coil unit is composed of or comprises the material aluminum. In particular, the at least one coil unit is an aluminum coil. In principle, it is preferred that the at least one coil unit is composed of or comprises a conductive material. It can also be preferred that the at least one coil unit is composed of or comprises an alloy of copper and/or aluminum.

A coil unit configured according to this embodiment has the advantage that it enables a particularly high output density. In this respect, a significantly higher output density can be achieved with a more compact construction mode in comparison to other materials.

Coil units which are adjacent to one another on a stator laminated core are preferably disposed at a spacing from one another in the circumferential direction by a coil spacing gap. The coil spacing gap is preferably constant in the axial direction and/or the radial direction. It may be preferable that the coil spacing gap decreases in the radial direction. In particular, the coil spacing gap may decrease in the radial direction from the stator external circumferential face toward the stator internal circumferential face, or vice versa. In particular, the coil spacing gap can vary linearly and/or convexly and/or concavely in the radial direction.

It is preferred in the case of a plurality of coil units that adjacent coil units are disposed equidistantly, i.e., respectively adjacent coil units are disposed with the same coil spacing gap relative to one another. Furthermore, this has the advantage that such stator segments can be manufactured and maintained particularly inexpensively.

In particular, it is preferable that the coil spacing gap between two adjacent coil units is configured as a cooling medium duct that allows a cooling medium to flow in the radial direction from the stator external circumferential face toward the stator internal circumferential face and/or vice versa. In particular, the cooling medium duct enables the cooling medium to flow through the stator laminated core in the radial direction.

The coil spacing gap configured as a cooling medium duct enlarges in a particularly advantageous manner a cross section of the stator laminated core through which the cooling medium for cooling the generator, in particular the stator segment or the stator laminated core, can flow. In particular, this leads to a more intensely cooled generator, which in this respect advantageously increases the efficiency of the generator. Furthermore, this has the advantage that the cooling medium, in addition to cooling, can also electrically isolate adjacent coil units from one another.

It can be preferred that an insulating element is disposed in one or more coil spacing gaps between two adjacent coil units. It can be particularly preferred that an insulating element is disposed between each adjacent coil unit in the respective coil spacing gap. The insulating element is, for example, a polymer or comprises any other electrically isolating material. Such an insulating element isolates adjacent coil units from one another.

According to a further preferred refinement, the stator segment comprises a cooling device and/or a cooling medium guide device, which is disposed, in particular in the axial direction, between the first and the second carrier plates, and conveys the cooling medium through the stator cooling ducts disposed between the first and the second carrier plates inward, in particular from the radially outer stator external circumferential face in the direction of the radially inner stator internal circumferential face; the cooling device preferably comprising: a cooling medium conveying unit, preferably a fan unit, in particular a ventilator, for generating a flow of the cooling medium; and/or a heat exchanger unit for cooling the heated cooling medium, wherein the heat exchanger unit is preferably disposed in the radial direction between the fan unit and the coil carrier segment, and preferably the heat exchanger unit is a fluid/air heat exchanger unit or air/air heat exchanger unit; and/or cooling medium guide device preferably comprising: one or more cooling medium lines; and/or one or more cooling medium guiding elements.

The flow of the cooling medium is to be understood in particular as a volumetric flow, mass flow and/or as a transient flow of the cooling medium.

Furthermore, the cooling device is configured in particular to convey the cooling medium through the stator cooling ducts disposed between the first pressure sheet of the stator laminated core and the first carrier plate and/or between the second pressure sheet of the stator laminated core and the second carrier plate in the radial direction from the inside to the outside.

In the case of a stator segment having a cooling medium guide device, a cooling medium conveying unit, for example as described above, is preferably disposed outside the generator. For example, the cooling medium conveying unit is disposed in a nacelle of the wind turbine. In this preferred embodiment, the cooling medium conveying unit conveys the cooling medium, in particular air, located in the generator, out of the generator through the air gap and the stator cooling ducts described above, for example into the environment of the nacelle. Furthermore, another or the same cooling medium conveying unit can suction air as a cooling medium from the environment of the nacelle and provide said cooling medium within the generator for cooling the stator or the stator segment and the rotor or rotor segment, as described above. It should be understood that air suctioned from the environment is passed through a water separator and/or an air filter, for example, before it is made available inside the generator for cooling the stator and/or rotor.

Some embodiments include a stator of a generator for a wind turbine. It should be understood that the stator is a stator for a generator. Furthermore, it should be understood that the generator is a generator for a wind turbine.

The stator is in particular a segmented stator. The stator is preferably a stator of a segmented generator. The stator comprises an annularly configured stator segment or a plurality of part-annularly configured stator segments which are disposed in an annular manner. Such a stator comprises a stator segment according to the disclosure and/or features of one of the previously described embodiments of the stator segment or a combination thereof.

In terms of further advantages, design variants and design details of the stator according to the disclosure and its refinements, reference is also made to the previous description of the corresponding features and refinements of the generator and the stator segment and the following descriptions of the rotor segment, the rotor, the wind turbine and the method.

Some embodiments include a rotor segment of a generator for a wind turbine. It is to be understood that the rotor segment is a rotor segment for a rotor, in particular for a segmented rotor. Furthermore, it is to be understood that the rotor is a rotor for a generator, in particular for a segmented generator.

The rotor segment of a rotor, in particular a segmented rotor of a segmented generator, for a wind turbine comprises a magnet carrier segment having an annular or part-annular geometry and a rotor internal circumferential face, and a plurality of magnet units which are disposed on the magnet carrier segment at a spacing from one another in a circumferential direction and form or define the rotor internal circumferential face, characterized in that in an axial direction two or a plurality of magnet units of the plurality of magnet units are disposed spaced apart from one another, wherein the magnet units disposed adjacently in the axial direction define a circumferential gap with a gap width for feeding and distributing a cooling medium.

The rotor segment preferably extends in the radial direction between a radially inner flange for fastening the rotor segment to the rotor main body flange of a bearing unit and the radially outer magnet carrier segment. The rotor segment by way of a rotor support section preferably extends between the radially inner flange for fastening the rotor segment to the rotor main body flange of the bearing unit and the radially outer magnet carrier segment. It is to be understood that the rotor segment can be configured in multiple parts or integrally. In particular, it should be understood that the rotor segment can be configured integrally from individual rotor segments welded to one another.

The circumferential gap of the rotor segment is configured in particular to feed the cooling medium to the stator segment in the radial direction. In particular, the circumferential gap is configured to feed a cooling medium between the rotor segment and the stator segment, which by way of the air gap is disposed at a spacing therefrom, in the radial direction, in particular proceeding from the circumferential gap outward in the axial direction. For this purpose, the circumferential gap is preferably disposed centrically to the extent of the rotor segment in the axial direction, in particular centrically between the magnet units disposed spaced apart in the axial direction.

The circumferential gap is preferably disposed so as to be co-aligned with the stator guide device in the axial direction. In particular, the circumferential gap is disposed so as to be centered in relation to the stator guide device in the axial direction. Preferably, the gap width of the circumferential gap is less than the stator guide device width. Preferably, the stator guide device width is at least 110%, 120%, 140%, 160%, 180%, 200%, 250%, 300% or more and at most 500%, 400%, 300%, 250%, 200%, 180%, 160%, 140%, 120%, 110% or less.

This has the advantage that the cooling medium can be fed to the stator laminated core in the axial direction not only from the outside to the inside, but also via the circumferential gap in the axial direction from the inside to the outside to the air gap, in particular to the stator external circumferential face and in particular the stator cooling ducts and the rotor internal circumferential face, for cooling. In particular, the cooling medium provided centrically in the axial direction can be provided toward the outside for cooling. This improves uniform cooling of the generator. Furthermore, the cooling medium can be conveyed at a lower output while performing an identical cooling output.

The rotor segment according to the disclosure and its refinements have features that make them particularly suitable for being used for a generator according to the disclosure and/or a wind turbine according to the disclosure and/or a method according to the disclosure and the respective refinements. In terms of further advantages, design variants and design details of the rotor segment according to the disclosure and its refinements, reference is also made to the previous description of the corresponding features and refinements of the generator, the stator segment, the stator and the following description of the corresponding features and refinements of the wind turbine and the method.

According to a preferred embodiment of the rotor segment, it is provided that the magnet carrier segment has at least one rotor laminated core, which extends in the axial direction between a first and a second pressure sheet and has at least one first feed duct that for a cooling medium extends between the first and/or the second pressure sheet and the circumferential gap, in particular within the rotor laminated core, in order to convey the cooling medium, which on the first and/or the second pressure sheet can enter the first feed duct through a first opening, to the circumferential gap in which said cooling medium can exit, in particular in the axial direction, through a second opening; and/or the plurality of magnet units are disposed equidistantly in a circumferential direction; and/or magnet units disposed adjacently in the circumferential direction define a second feed duct for a cooling medium in order to convey the cooling medium, proceeding from the first and/or the second pressure sheet, in the direction of the circumferential gap, in particular in the axial direction, and/or the magnet units comprise one, two or more rows of magnets which are preferably disposed at a spacing from one another in the circumferential direction, in particular equidistantly; and/or a row of magnets comprises one or a plurality of magnet blocks which are preferably disposed next to one another in the axial direction.

In particular, it should be understood that the first feed duct is offset in the circumferential direction in comparison to the second feed duct. A first feed duct is preferably disposed in the circumferential direction between two second feed ducts, in particular disposed centrically between two second feed ducts. Furthermore, it can be preferred that a second feed duct is disposed between two first feed ducts, in particular is disposed centrically between two first feed ducts. In particular, it is preferred that the at least one first feed duct is disposed on the outside in the radial direction in comparison to the at least one second feed duct. Furthermore, it is preferred that the at least one first feed duct orthogonally to the circumferential direction has a larger duct cross section in comparison to the at least one second feed duct.

Furthermore, it is preferred that the at least one second feed duct is open or is configured to be open in the radial direction, i.e., in the direction of the stator external circumferential face. In particular, it should be understood that the magnet units disposed adjacently in the circumferential direction each form a groove-like second feed duct. In particular, the at least one second feed duct is configured to provide the cooling medium in the axial direction, proceeding from the first and/or the second pressure sheet of the rotor laminated core, in the direction of the circumferential gap. It is to be understood in particular that the cooling medium provided in the at least one second feed duct is provided to the stator cooling ducts for cooling the stator laminated core and the at least one coil unit.

In particular, the at least one first feed duct is configured to provide the cooling medium to the circumferential gap in the axial direction, proceeding from the first and/or the second pressure sheet of the rotor laminated core. In particular, it should be understood that the cooling medium provided in the at least one first feed duct for cooling the stator laminated core and the at least one coil unit is provided to the stator cooling ducts proceeding from the circumferential gap of the rotor segment and/or the stator guide device of the stator segment in the direction of the first and/or the second pressure sheet of the stator laminated core or the rotor laminated core.

The at least one first feed duct preferably comprises two, three or more tubular feed ducts. In particular, a first feed duct is composed of three tubular feed ducts. In particular, this has advantages in terms of manufacturing technology, since first feed ducts configured in this manner can be used for centering during the manufacture of the rotor segment. It can also be preferred that the at least first feed duct has a type of triangular cross section, wherein one, two or three sides of the triangular cross section can be convex and/or concave. As a result, a comparatively higher cooling capacity can be achieved.

Furthermore, it is preferred that the at least one second feed duct has a substantially square or rectangular cross section. It is to be understood that the second feed ducts are formed in particular by magnets or magnet covers disposed adjacently in the circumferential direction, the inner surface of the rotor laminated core and the external face of the stator.

In particular, it is to be understood that the spacing in the circumferential direction between adjacent magnet units is preferably greater than the spacing in the circumferential direction between adjacent magnet rows of a magnet unit.

This has the advantage that the cooling medium for cooling can be fed to the stator laminated core in the axial direction not only from the outside inwards via the at least one second feed duct, but also via the at least one feed duct to the circumferential gap and in this respect in the axial direction from the inside to the outside to the air gap, in particular to the stator external circumferential face and in particular the stator cooling ducts and the rotor internal circumferential face. In particular, the cooling medium for cooling provided centrically in the axial direction can be provided toward the outside. This improves uniform cooling of the generator. Furthermore, the cooling medium can be conveyed at a lower output while performing an identical cooling output.

Some embodiments include a rotor of a generator for a wind turbine. It should be understood that the rotor is a rotor for a generator. Furthermore, it should be understood that the generator is a generator for a wind turbine.

The rotor is in particular a segmented rotor. Preferably, the rotor is a rotor of a segmented generator. The rotor comprises an annularly configured rotor segment, or a plurality of rotor segments configured in a part-annular manner which are disposed in an annular manner. Such a rotor comprises a rotor segment according to the disclosure and/or features of one of the previously described embodiments of the rotor segment or a combination thereof.

In terms of further advantages, design variants and design details of the rotor according to the disclosure and its refinements, reference is also made to the previous description of the corresponding features and refinements of the generator, the stator segment, the stator, the rotor segment and the following descriptions of the wind turbine and the method.

According to a preferred refinement of the generator, the stator and the rotor define a generator interior, comprising a sealing device which seals the generator interior from an environment in a substantially airtight and/or dust-tight manner, wherein the sealing device preferably comprises a labyrinth sealing unit and/or a brush unit.

This has the advantage that the air gap and/or the stator cooling duct and/or the cooling medium duct and/or the circumferential gap and/or the first and/or the second feed duct are/is not contaminated, in particular not blocked, nor is the cooling capacity minimized. Furthermore, this minimizes the necessary maintenance intervals of the generator in an advantageous manner.

Some embodiments include a wind turbine.

In terms of further advantages, design variants and design details of the wind turbine according to the disclosure and its refinements, reference is also made to the previous description of the corresponding features and refinements of the generator, the stator segment, the stator, the rotor segment and the rotor and the following descriptions of the method.

Some embodiments include a method for cooling a generator.

The method for cooling the generator includes in particular providing a generator as described above according to the disclosure or its refinements. Furthermore, the method includes generating a flow of a cooling medium through the provided generator. The method also includes guiding the cooling medium through a stator cooling duct of a stator laminated core of a stator segment of the provided generator, in particular in a radial direction. Furthermore, the method can include guiding the cooling medium through a circumferential gap of a rotor segment of the provided generator, in particular between magnet units disposed spaced apart from one another in an axial direction. Finally, the method can also comprise guiding the cooling medium through a coil spacing gap of a rotor segment of the generator provided, in particular between coil units of the at least one coil unit disposed spaced apart from one another in a circumferential direction, in particular in the radial direction.

The method according to the disclosure and its possible refinements have features or method steps that make them particularly suitable to be used for a generator according to the disclosure and/or a wind turbine according to the disclosure and/or a stator segment according to the disclosure and/or a stator according to the disclosure and/or a rotor segment according to the disclosure and/or a rotor according to the disclosure and the respective refinements. In terms of further advantages, design variants and design details of the method according to the disclosure and its refinements, reference is made to the preceding description of the corresponding features and refinements of the generator, the stator segment, the stator, the rotor segment, the rotor and the wind turbine.

In a preferred embodiment of the method for cooling, it is provided that the step of conducting the cooling medium through a stator cooling duct comprises, in particular, guiding the cooling medium through a stator cooling duct, which is disposed in an axial direction between a first and a second carrier plate, from a radially outer stator external circumferential face in the direction of an inner stator internal circumferential face that in terms of the stator external circumferential face is on the inside; and/or guiding the cooling medium through a stator cooling duct, which is disposed in an axial direction between a first carrier plate and a first pressure sheet and/or between a second carrier plate and a second pressure sheet, from a radially inner stator internal circumferential face in the direction of a stator external circumferential face that in terms of the stator internal circumferential face is on the outside; and/or the step of guiding the cooling medium through a circumferential gap comprises, in particular, feeding and distributing the cooling medium from the circumferential gap on the stator laminated core, in particular by way of a stator external circumferential face; and/or the method further preferably comprises: diverting and/or dividing the cooling medium supplied from the circumferential gap with a stator guide device by way of a stator external circumferential face, in particular in an axial direction; and/or feeding the cooling medium to the circumferential gap, in particular through a first feed duct which, starting from a first and/or a second pressure sheet of a magnet carrier segment, extends to the circumferential gap; and/or feeding the cooling medium to the stator external circumferential face in the direction of the circumferential gap through a second feed duct, which extends from a first and/or a second pressure sheet of a magnet carrier segment in the direction of the circumferential gap.

### BRIEF DESCRIPTION OF THE SEVERAL VIEWS OF THE DRAWINGS

Embodiments will be explained by way of example with the aid of the appended figures.

FIG. 1 shows a schematic, three-dimensional view of an embodiment of a wind turbine in an operating state.

FIG. 2 shows a schematic, three-dimensional sectional view of a preferred embodiment of a segmented generator.

FIG. 3 shows a schematic, three-dimensional view of a preferred embodiment of a stator segment in a circumferential direction.

FIG. 4 shows a schematic, three-dimensional view of the stator segment illustrated in FIG. 3, substantially in an axial direction.

FIG. 5 shows a schematic, three-dimensional detailed view of the stator segment shown in FIG. 3.

FIG. 6 shows a schematic, three-dimensional view of a preferred embodiment of a stator laminated core with coil units disposed thereon.

FIGS. 7a and 7b show a schematic, two-dimensional sectional view in the axial direction of a stator laminated core with coil units disposed thereon, in two different preferred embodiments.

FIG. 8 shows a schematic, three-dimensional overall view of a preferred embodiment of a rotor segment.

FIG. 9 shows a schematic, three-dimensional detailed view of the rotor segment shown in FIG. 8.

FIG. 10 shows a schematic, three-dimensional detailed view of a generator segment with a stator segment according to the preferred embodiment shown in FIGS. 3 and 5, and a rotor segment according to the preferred embodiment shown in FIGS. 8 and 9.

FIG. 11 shows a schematic flowchart showing steps of a preferred embodiment of a method for cooling a generator.

### DETAILED DESCRIPTION

In the figures, identical or substantially functionally identical or similar elements are denoted by the same reference designations. If general reference is made to a generator, rotor or stator in the present description of the figures, this in principle includes a segmented generator, segmented rotor or segmented stator, unless this is expressly described otherwise.

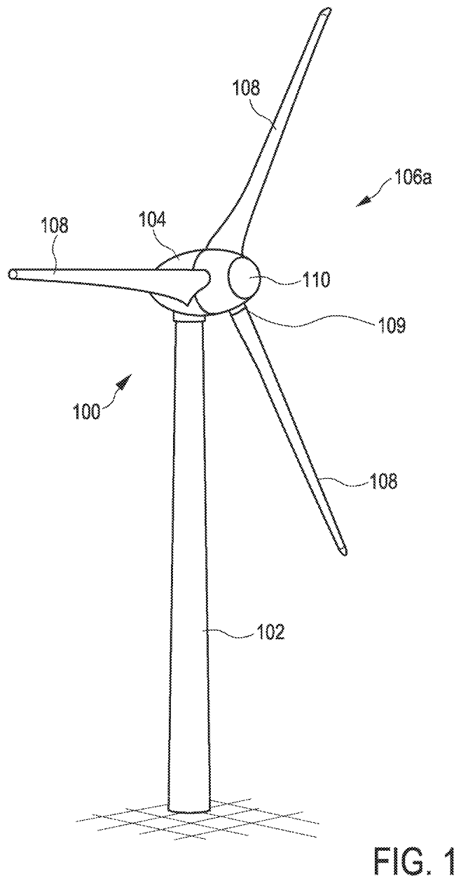

FIG. 1 shows a schematic three-dimensional view of an embodiment of a wind turbine. FIG. 1 shows in particular a wind turbine 100 with a tower 102 and a nacelle 104. An aerodynamic rotor 106a with three rotor blades 108 and a spinner 110 is disposed on the nacelle 104. During operation, the aerodynamic rotor 106a is set in rotation by the wind and thereby drives a generator 1, in particular a rotor 106 of the generator 1. The generator 1 is disposed in particular outside the nacelle 104. The tower 102 has, in particular, wind turbine steel tower ring segments with flange segments. As a result, the tower 102 is constructed using components that are easy to transport and that can also be connected with great precision and with little effort.

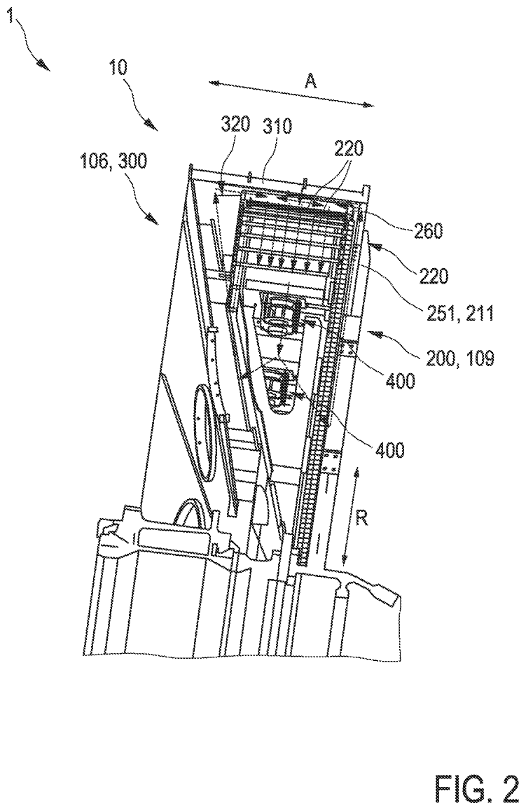

A generator segment 10 of a segmented generator 1 is shown in FIG. 2. The segmented generator 1 comprises a segmented rotor 106 and a segmented stator 109. In the preferred embodiment of the segmented generator 1 illustrated in FIG. 2, the segmented rotor 106 has a plurality of rotor segments 300, and the segmented stator 109 has a plurality of stator segments 200. In particular, in the present case the generator segment 10 has one rotor segment 300 and one stator segment 200. The preferred embodiment of the segmented generator 1 illustrated in FIG. 2 is configured as an external rotor. In the case of a segmented generator 1 configured as an external rotor, the stator 109 is disposed inside the rotor 106. In this preferred embodiment, the rotor completely encloses a stator external circumferential face of the stator 109 with a rotor internal circumferential face.

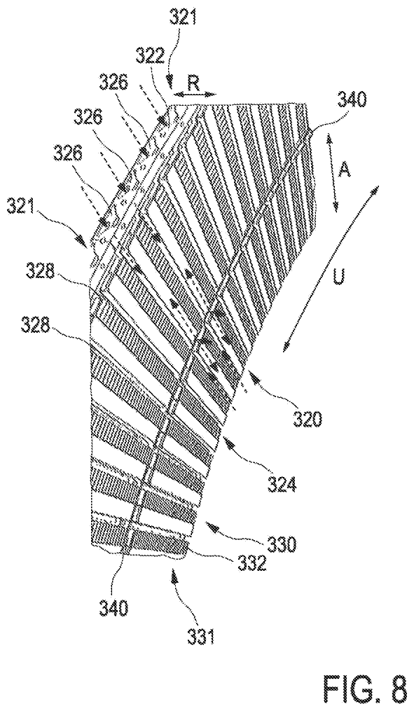

The rotor segment illustrated in FIG. 2 comprises a magnet carrier segment 310 and a plurality of magnet units 330. The magnet carrier segment 310 has an annular or part-annular geometry and a rotor internal circumferential face 320. The plurality of magnet units 330 are disposed on the magnet carrier segment 310 at a spacing from one another in a circumferential direction U, and form or define a rotor internal circumferential face 320. Furthermore, the magnet units 330 are disposed spaced apart from one another in an axial direction A, so that the magnet units 330 disposed adjacently in the axial direction A define a circumferential gap 340 with a gap width for feeding and distributing a cooling medium. This disposal of the magnet units 330 on the magnet carrier segment 310 with the circumferential gap 340 is shown schematically in detail in FIGS. 8 to 10 for a preferred embodiment.

The stator segment depicted in FIG. 2 comprises a coil carrier segment and at least one stator laminated core 220. The coil carrier segment 210 has an annular or part-annular geometry and a stator circumferential structure 211. The stator laminated core 220 is disposed on the stator circumferential structure 211. Furthermore, a plurality of coil units 260 are disposed on the stator laminated core 220.

The stator segment also has a cooling device 400 for cooling the generator 1 with a cooling medium. In the preferred embodiment, the cooling medium is air. The cooling device 400 comprises a cooling medium conveying unit configured as a fan, which generates a flow of the cooling medium inside the generator 1. The flow is to be understood in particular as a volumetric flow, mass flow and/or transient flow of the cooling medium. Furthermore, the cooling device 400 has a heat exchanger unit for cooling the heated cooling medium. The heat exchanger unit is disposed in the radial direction R between the fan unit and the coil carrier segment 210.

Alternatively, it may also be preferred (not illustrated) that the generator 1 shown in FIG. 2 or its generator segments 10, in particular the stator segments, has/have a cooling medium guide device which directs and/or guides a generated flow of the cooling medium via one or more cooling medium lines and/or one or more cooling medium guide elements. In particular, it is preferred in this alternative that the cooling medium guide device conveys the flow of cooling medium heated by the generator 1, in particular by the active parts, out of the generator 1 or the generator segments 10 and conveys a cooling medium that is colder than the heated cooling medium from the environment into the generator 1 or the generator segments 10.

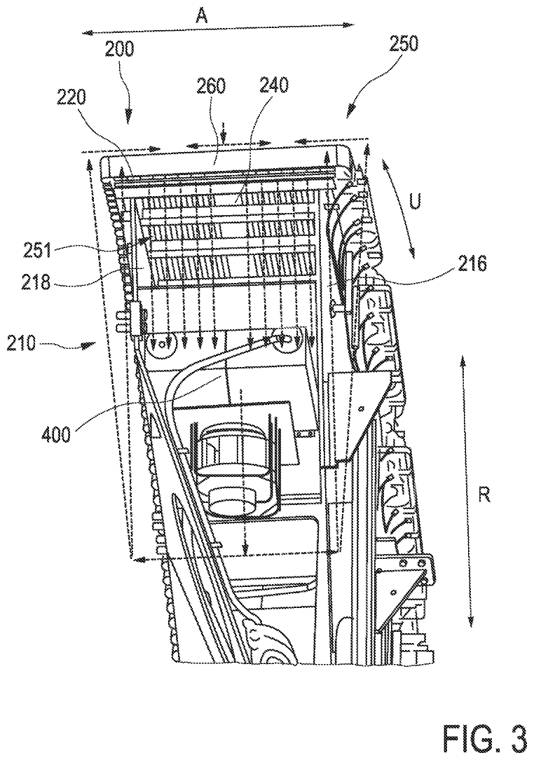

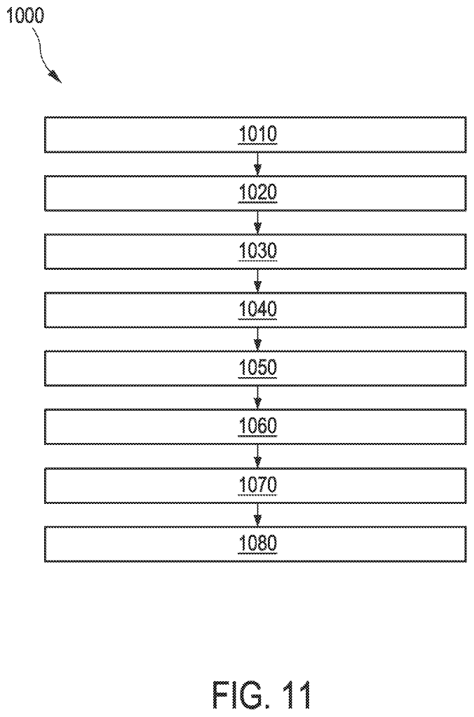

The flow of cooling medium generated within the generator—in all preferred embodiments described here the cooling medium is preferably air—is represented by dashed arrows with reference to FIG. 2 as well as with reference to FIGS. 3, 5, 6 and 8 to 10 and described in detail with reference to the flowchart of the method for cooling a generator illustrated in FIG. 11 (see below).

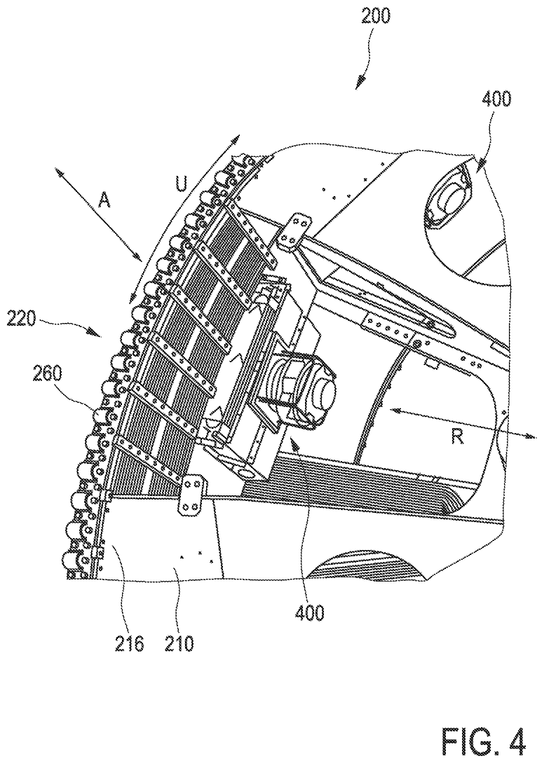

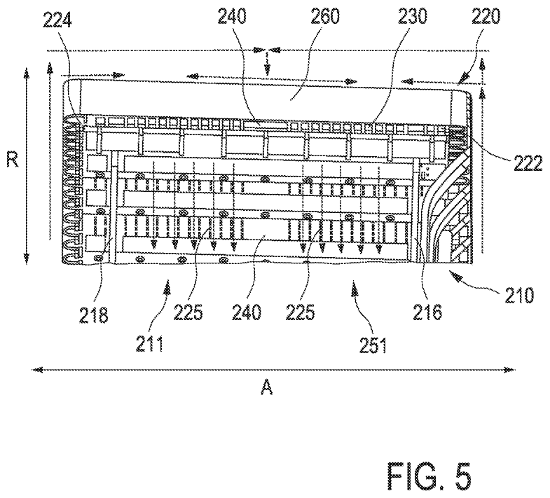

FIG. 3 and FIG. 4 each show a schematic, three-dimensional view of a preferred embodiment of a stator segment 200 substantially in a circumferential direction U (FIG. 3) and an axial direction A (FIG. 4). Shown in FIG. 5 is a schematic, three-dimensional detailed view of the stator segment 200 illustrated in FIG. 3.

The coil carrier segment 210 of the stator segment 200 shown in FIGS. 3 to 5 has a first and a second carrier plate 216, 218 between which the coil carrier segment 210 extends in the axial direction A with a coil carrier segment width. Furthermore, the stator segment 200 has a stator laminated core 220 with a first and a second pressure sheet 222, 224. The stator laminated core 220 extends between the first and the second pressure sheets 222, 224 by way of a stator laminated core width that is greater than the coil carrier segment width.

It can be seen that between the first carrier plate 216 and the first pressure sheet 222 and between the second carrier plate 218 and the second pressure sheet 224 are disposed a plurality of adjacent stator lamination stacks 230 of the at least two stator lamination stacks 230 spaced parallel to one another in the axial direction A and each forming a stator cooling duct 225 through which the cooling medium can be guided in the radial direction R. For this purpose, at least one spacer element 231 is preferably disposed between the adjacently disposed stator lamination stacks 230. The cooling medium is guided in the radial direction R from a radially inner stator internal circumferential face 251 in the direction of a stator external circumferential face 250 which is radially outside in terms of the stator internal circumferential face 251. It can also be seen that, between the first carrier plate 216 and the second carrier plate 218, are disposed a plurality of adjacent stator lamination stacks 230 of the at least two stator lamination stacks 230 spaced parallel to one another in the axial direction A and each forming a stator cooling duct 225 through which the cooling medium can be guided in the radial direction R. The cooling medium is guided in the radial direction R from a radially outer stator external circumferential face 250 towards a stator internal circumferential face 251 which is radially inside in terms of the stator external circumferential face 250. A stator guide device 240 is also disposed in the axial direction A centrically between the first and the second pressure sheets 222, 224 of the stator laminated core, which diverts the air axially outwards via a circumferential gap 340 (not shown) formed by a rotor segment 300 in the direction of the first and the second pressure sheet 222, 224 for cooling the stator laminated core 220.

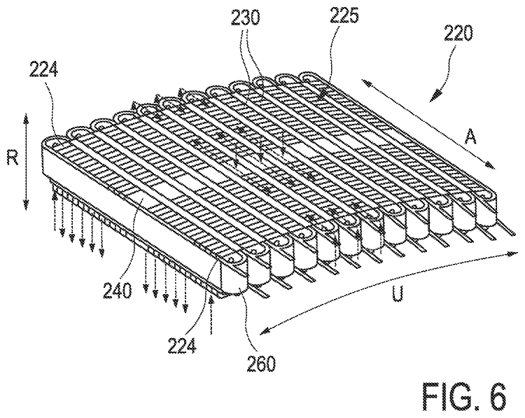

FIG. 6 shows a schematic, three-dimensional view of the previously described stator laminated core 220. In particular, this stator laminated core 220 demonstrates the previously described, centrically disposed stator guide device 240. The stator guide device 240 is configured to divert and/or divide a cooling medium supplied inwardly in the radial direction R in the direction of the stator guide device 240 via a stator external circumferential face 250 of the stator laminated core 220 in the axial direction A. In the present case, the stator guide device 240 has a stator guide device width in the axial direction A that is greater than a width of a stator lamination stack 230. In the preferred embodiment of the stator laminated core 220 illustrated in FIG. 6, the stator guide device 240 is disposed between two stator lamination stacks 230, spaced apart by the stator cooling duct width and disposed centrically between the first and the second pressure sheets 222, 224. It can be seen that a plurality of stator lamination stacks 230 are disposed equidistantly between the first and/or the second pressure sheet 222, 224 or between the stator guide device 240 and the first and/or the second pressure sheet 222, 224.

Twelve coil units 260, for example made of copper, are also disposed on the stator laminated core illustrated in FIG. 6. Stator segments 200 having corresponding stator laminated cores 220 with coil units 260 disposed thereon can also be derived from FIGS. 3 to 5 and 10.

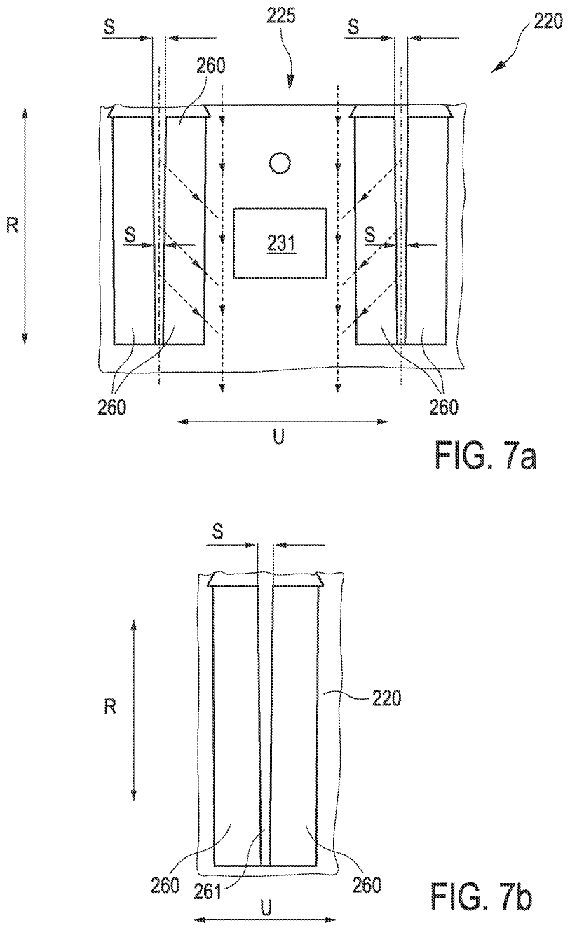

FIGS. 7a and 7b show a schematic, two-dimensional sectional view of a stator laminated core 220 with coil units 260 disposed thereon in the axial direction A. The coil units 260 disposed on a stator laminated core 220 in relation to coil units 260 disposed adjacently to one another are disposed equidistantly from one another in the circumferential direction U with a coil spacing gap S. The coil spacing gap S is preferably constant over a height in the radial direction R and a length in the axial direction A, as is illustrated schematically in FIG. 7a, for example. It may also be preferable for the coil spacing gap S to vary over a height in the radial direction R, in particular to decrease starting from the stator external circumferential face in the direction of the stator internal circumferential face, as is shown schematically in FIG. 7b, for example.

In the preferred embodiment shown in FIG. 7a, the coil spacing gap S between two adjacent coil units 260 is configured as a cooling medium duct through which the cooling medium can be guided in or along the axial direction A. The cooling medium flowing between the coil units 260 in the axial direction A is fed to the stator cooling ducts 225, which as a function of the spacer element 231 extend between adjacent stator lamination stacks 230 and through which the cooling medium can be guided in the radial direction R. In a particularly advantageous manner, this leads to an additional cooling effect, which in turn increases the efficiency of a generator with such a stator segment. In the preferred embodiment shown in FIG. 7b, an insulating element 261 is disposed in the coil spacing gap S between two adjacent coil units 260. The insulating element 261 electrically isolates a coil unit 260 from a coil unit 260 disposed adjacently thereto.

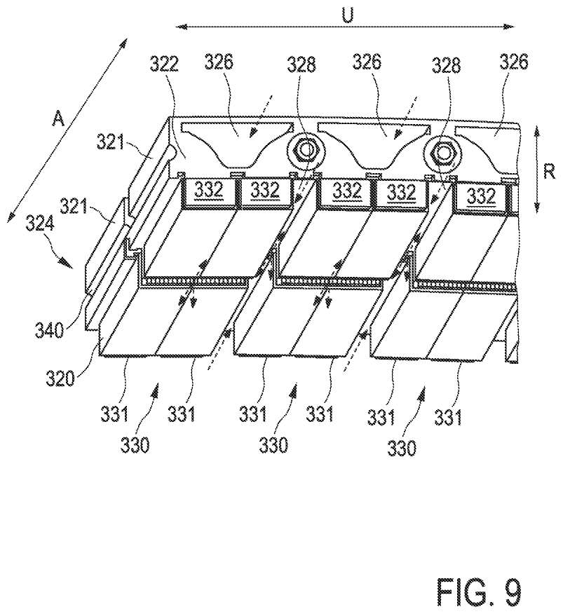

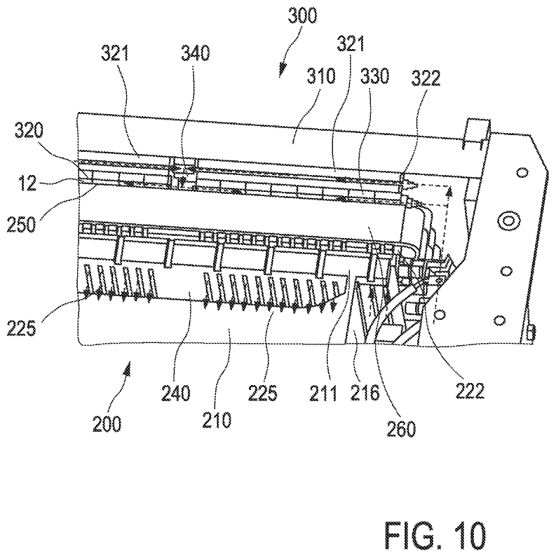

FIG. 8 shows a schematic, three-dimensional overall view of a preferred embodiment of a rotor segment 300. Illustrated in FIG. 9 is a schematic, three-dimensional detailed view of the rotor segment illustrated in FIG. 8. Such a rotor segment 300 comprises a magnet carrier segment 310 with an annular or part-annular geometry and a rotor internal circumferential face 320 (not shown). Furthermore, the rotor segment 300 has a plurality of magnet units 330 which are disposed on the magnet carrier segment 310 at a spacing from one another in a circumferential direction U, and form or define the rotor internal circumferential face 320. A plurality of magnet units 330 are disposed at a spacing from one another in the axial direction A, with the magnet units 330 disposed adjacently in the axial direction A defining a circumferential gap 340 with a gap width for feeding and distributing a cooling medium. This is illustrated in FIG. 10, for example.

In particular, FIGS. 8 and 9 show a rotor laminated core 321 of a rotor segment 300 and magnet units 330 disposed thereon. The magnet carrier segment 310, which has the rotor laminated core 321, is not illustrated in FIGS. 8 and 9. The rotor laminated core 321 extends in the axial direction A between a first and a second pressure sheet 322, 324 and has a plurality of first feed ducts 326 for a cooling medium. The cooling duct extends between the first and/or the second pressure sheet 322, 324 and the circumferential gap 340 within the rotor laminated core 321 so as to convey the cooling medium, which on the first and/or the second pressure sheet 322, 324 can enter through a first opening into the first feed duct 326, to the circumferential gap 340, in particular in the axial direction A, in which circumferential gap 340 said cooling medium can exit through a second opening.

The magnet units illustrated in FIGS. 8 and 9 are disposed equidistantly in the circumferential direction U. In particular, in this preferred embodiment of the rotor segment, the magnet units 330 disposed adjacently in the circumferential direction U form a second feed duct 328 for a cooling medium, in order to convey the cooling medium in the axial direction A, proceeding from the first and/or the second pressure sheet 322, 324 in the direction of the circumferential gap 340. In the present embodiment, the magnet units 330 are each formed in two rows, with the rows of magnets being disposed equidistantly from one another in the circumferential direction U. Each row of magnets 331 is formed from a plurality of magnet blocks 332 disposed next to one another in the axial direction A. The respective row of magnets 331 is preferably covered by a magnet cover. In FIG. 8, every other row of magnets 331 is shown without a magnet cover (for reasons of illustration), so that the individual magnet blocks 332 of a row of magnets 331 are visible.

FIG. 10 is a schematic, three-dimensional detailed view of a generator segment with a stator segment according to the preferred embodiment illustrated in FIGS. 3 and 5, and a rotor segment according to the preferred embodiment illustrated in FIGS. 8 and 9. It can be seen that the rotor segment 300, or the rotor internal circumferential face 320, in relation to the stator segment 200, in particular the stator external circumferential face 250, is disposed in the radial direction R with an air gap 12. It can be seen how, proceeding from the circumferential gap 340 disposed centrically to the rotor segment 300 and centered in relation to the stator guide device 240, the cooling medium fed inward in the radial direction R to the stator guide device 240 is divided at the stator guide device 240 and diverted in the axial direction A along the stator external circumferential face 250 and the rotor internal circumferential face 320 in the air gap 12. It can furthermore be seen how the cooling medium is fed to the circumferential gap 340 from the outside in the axial direction A, proceeding from the first pressure sheet 322 of the rotor laminated core 321, through the first feed duct 326 and through the second feed duct 328 to the stator external circumferential face 250 and the rotor internal circumferential face 320 in the air gap 12. It can furthermore also be seen how the cooling medium fed to the air gap 12 is guided from the stator external circumferential face 250 in the radial direction R through the stator laminated core in the direction of the radially inner stator internal circumferential face 251, in the direction of a cooling device 400 (not illustrated) which is disposed in the axial direction between the first and the second carrier plate 216, 218, so as to be radially further inward. It can also be seen in FIG. 10 that between the first pressure sheet 222 and the first carrier plate 216, the cooling medium flows in the radial direction through a stator cooling duct 225 from a radially inner stator internal circumferential face 251 in the direction of a stator external circumferential face 250 lying on the outside in terms of the stator internal circumferential face 251.

FIG. 11 shows a schematic flowchart that by way of example represents steps of a preferred embodiment of a method 1000 for cooling a generator 1, in particular a segmented generator 1, of a wind turbine 100. The method 1000 comprises providing 1010 a segmented generator 1, as illustrated for example in a preferred embodiment in FIG. 2. The method 1000 also comprises the step of generating 1020 a flow of a cooling medium through the provided generator 1. The method 1000 furthermore comprises the steps of guiding 1030 the cooling medium through a stator cooling duct 225 of a stator laminated core 220 of a stator segment 200 of the provided generator 1, in particular in a radial direction R, and of guiding 1040 the cooling medium through a circumferential gap 340 of a rotor segment 300 of the provided generator 1, in particular between magnet units 330 disposed spaced apart from one another in an axial direction A.

The method step of guiding 1030 the cooling medium through a stator cooling duct 225 comprises in particular guiding the cooling medium through a stator cooling duct 225, which is disposed in an axial direction A between a first and a second carrier plate 216, 218, from a radially outer stator external circumferential face 250 in the direction of a stator internal circumferential face 251 lying on the inside in terms of the stator external circumferential face 250.

Additionally and/or alternatively, guiding comprises guiding the cooling medium through a stator cooling duct 225, which is disposed in an axial direction A between a first carrier plate 216 and a first pressure sheet 222 and/or between a second carrier plate 218 and a second pressure sheet 224, from a radially inner stator internal circumferential face 251 in the direction of a stator external circumferential face 250 which is on the outside in terms of the stator internal circumferential face 251.

It is to be understood that the step of guiding 1040 the cooling medium through a circumferential gap 340 comprises in particular feeding and distributing the cooling medium from the circumferential gap 340 onto the stator laminated core 220, in particular by way of a stator external circumferential face 250.

Furthermore, it can be preferred that the method 1000 comprises diverting and/or dividing 1050 the cooling medium fed from the circumferential gap 340 with a stator guide device 240 by way of a stator external circumferential face 250, in particular in an axial direction A.

Additionally and/or alternatively, the method 1000 can comprise feeding the cooling medium to the circumferential gap 340, in particular through a first feed duct 326, which extends from a first and/or a second pressure sheet 322, 324 of a magnet carrier segment 310 to the circumferential gap 340 and/or feeding the cooling medium to the stator external circumferential face 250 in the direction of the circumferential gap 340 through a second feed duct 328, which extends from a first and/or a second pressure sheet 322, 324 of a magnet carrier segment 310 in the direction of the circumferential gap 340.

In particular, it may also be preferred to guide 1080 the cooling medium through a coil spacing gap S of a rotor segment 300 of the provided generator 1, in particular between coil units 260 of the at least one coil unit 260 disposed spaced apart from one another in a circumferential direction U, in particular in the radial direction R. Shown in FIG. 7a is a stator laminated core with a corresponding coil spacing gap S of a stator segment 200.

Schematically illustrated in FIGS. 2, 5, 9 and 10 is a flow of a cooling medium generated 1020 and guided 1030, 1040 according to the method 1000 within a provided 1010 generator 1 or generator segment 10 and corresponding stator and rotor segments 200, 300 (arrows in dashed lines).

### LIST OF REFERENCE SIGNS

1 Generator
10 Generator segment
12 Air gap
100 Wind turbine
102 Tower
104 Nacelle
106 Rotor
106a Aerodynamic rotor
108 Rotor blades
109 Stator
110 Spinner
200 Stator segment
210 Coil carrier segment
211 Stator circumferential structure
216 First carrier plate
218 Second carrier plate
220 Stator laminated core
222 First pressure sheet of the stator laminated core
224 Second pressure sheet of the stator laminated core
225 Stator cooling duct
230 Stator lamination stack
231 Spacer element
240 Stator guide device
250 Stator external circumferential face
251 Stator internal circumferential face
260 Coil unit
261 Insulating element
300 Rotor segment
310 Magnet carrier segment
320 Rotor internal circumferential face
321 Rotor laminated core
322 First pressure sheet
324 Second pressure sheet
326 First feed duct
328 Second feed duct
330 Magnet unit
331 Rows of magnets
332 Magnet blocks
340 Circumferential gap
400 Cooling device
A Axial direction
R Radial direction
S Coil spacing gap
U Circumferential direction

1. A stator segment of a stator of a generator for a wind turbine, comprising:
a coil carrier segment having an annular or part-annular geometry and a stator circumferential structure; and
at least one stator laminated core which is configured to receive at least one coil unit and is disposed on the stator circumferential structure;
wherein the at least one stator laminated core has at least two stator lamination stacks, wherein adjacent stator lamination stacks of the at least two stator lamination stacks are in each case spaced parallel to one another in an axial direction and forming in each case one stator cooling duct with a stator cooling duct width through which a cooling medium can be guided.

2. The stator segment as claimed in claim 1, the stator laminated core comprising a stator guide device for diverting and/or dividing a cooling medium that is fed inward, in a radial direction, in the direction of the stator guide device, by way of a stator external circumferential face of the at least one stator laminated core, in the axial direction, wherein the stator guide device in the axial direction has a stator guide device width that is larger than a width of a stator lamination stack of the at least two stator lamination stacks.

3. The stator segment as claimed in claim 1, wherein:
the coil carrier segment has a first and a second carrier plate, between which the coil carrier segment by way of a coil carrier segment width extends in the axial direction, and the stator laminated core has a first and a second pressure sheet between which the stator laminated core extends by way of a stator laminated core width which is greater than the coil carrier segment width;
wherein, between the first carrier plate and the second carrier plate are disposed at least two adjacent stacks of stator laminations of the at least two stacks of stator laminations spaced parallel to one another in the axial direction and forming in each case a stator cooling duct through which the cooling medium can be guided, in the radial direction, from a radially outer stator external circumferential face in the direction of a stator internal circumferential face that is radially inside in terms of the stator external circumferential face;
wherein, between the first carrier plate and the first pressure sheet and/or between the second carrier plate and the second pressure sheet are disposed at least two adjacent stacks of stator laminations of the at least two stacks of stator laminations spaced parallel to one another in the axial direction and forming in each case a stator cooling duct through which the cooling medium can be guided, in the radial direction, from a radially inner stator internal circumferential face in the direction of a stator external circumferential face that is radially outside in terms of the stator internal circumferential face; and/or
wherein the stator guide device, between two stator lamination stacks of the at least two stator lamination stacks, disposed spaced apart in the axial direction, and is in each case disposed spaced apart by the stator cooling duct width; and/or
wherein the stator guide device is disposed between the first and the second pressure sheet and so as to be centric.

4. The stator segment as claimed in claim 1, wherein a plurality of stator lamination stacks of the at least two stator lamination stacks are disposed equidistantly between the first and/or the second pressure sheet, between the stator guide device and the first and/or the second pressure sheet.

5. The stator segment as claimed in claim 1,
comprising at least one coil unit, which is disposed on the at least one stator laminated core, wherein the at least one coil unit is composed of or comprises the material copper; and/or
wherein coil units of the at least one coil unit that are adjacent in the circumferential direction are disposed with a coil spacing gap, equidistantly from one another;
wherein the coil spacing gap between two adjacent coil units of the at least one coil unit is configured as a cooling medium duct through which the cooling medium can be guided in the radial direction; and/or
wherein an insulating element is disposed in the coil spacing gap between two adjacent coil units of the at least one coil unit, said insulating element electrically isolating a coil unit of the at least one coil unit in relation to an adjacently disposed coil unit of the at least one coil unit.

6. The stator segment as claimed in claim 1, comprising a cooling device and/or a cooling medium guide device which is disposed, in the axial direction, between the first and the second carrier plates and conveys the cooling medium through the stator cooling ducts disposed between the first and the second carrier plates inward, from the radially outer stator external circumferential face in the direction of the radially inner stator internal circumferential face;
the cooling device comprising:
a cooling medium conveying unit including a fan unit and/or a ventilator, for generating a flow of the cooling medium; and/or
a heat exchanger unit for cooling the heated cooling medium, wherein the heat exchanger unit is disposed in the radial direction between the fan unit and the coil support segment, and the heat exchanger unit is a fluid/air heat exchanger unit; and/or
a cooling medium guide device comprising:
one or more cooling medium lines; and/or
one or more cooling medium guide elements.

7. A stator of a generator of a wind turbine, comprising an annularly configured stator segment as claimed in claim 1.

8. A rotor segment of a rotor for a wind turbine, comprising:
a magnet carrier segment having an annular or part-annular geometry and a rotor internal circumferential face, and
a plurality of magnet units which are disposed on the magnet carrier segment at a spacing from one another in a circumferential direction and form or define the rotor internal circumferential face;
wherein, in an axial direction two or a plurality of magnet units of the plurality of magnet units are disposed spaced apart from one another, wherein the magnet units disposed adjacently in the axial direction define a circumferential gap with a gap width for feeding and for distributing a cooling medium.

9. The rotor segment as claimed in claim 8, wherein:
the magnet carrier segment has at least one rotor laminated core, which extends in the axial direction between a first and a second pressure sheet and has at least one first feed duct that for a cooling medium extends between the first and/or the second pressure sheet and the circumferential gap, within the rotor laminated core, in order to convey the cooling medium, which on the first and/or the second pressure sheet can enter the first feed duct through a first opening, to the circumferential gap in which said cooling medium can exit, in the axial direction, through a second opening; and/or
the plurality of magnet units are disposed equidistantly in a circumferential direction; and/or
magnet units disposed adjacently in the circumferential direction define a second feed duct for a cooling medium in order to convey the cooling medium, proceeding from the first and/or the second pressure sheet, in the direction of the circumferential gap, in the axial direction; and/or
the magnet units comprise one, two or more rows of magnets which are disposed at a spacing from one another in the circumferential direction equidistantly; and/or
a row of magnets comprises one or a plurality of magnet blocks which are disposed next to one another in the axial direction.

10. A rotor of a generator of a wind turbine, comprising an annularly configured rotor segment as claimed in claim 8.

11. A generator of a wind turbine, comprising:
a stator as claimed in claim 7; and
a rotor comprising an annularly configured rotor segment including:
a magnet carrier segment having an annular or part-annular geometry and a rotor internal circumferential face, and
a plurality of magnet units which are disposed on the magnet carrier segment at a spacing from one another in a circumferential direction and form or define the rotor internal circumferential face;
wherein, in an axial direction two or a plurality of magnet units of the plurality of magnet units are disposed spaced apart from one another, wherein the magnet units disposed adjacently in the axial direction define a circumferential gap with a gap width for feeding and for distributing a cooling medium.

12. The generator as claimed in claim 11, wherein the stator and the rotor define a generator interior, comprising a sealing device which seals the generator interior from an environment in a substantially air-tight and/or dust-tight manner, wherein the sealing device comprises a labyrinth sealing unit and/or a brush unit.

13. A wind turbine comprising a generator as claimed in claim 11.

14. A method for cooling a generator of a wind turbine, comprising:
providing a generator comprising:
a stator comprising an annularly configured stator segment including:
a coil carrier segment having an annular or part-annular geometry and a stator circumferential structure; and
at least one stator laminated core which is configured to receive at least one coil unit and is disposed on the stator circumferential structure;
wherein the at least one stator laminated core has at least two stator lamination stacks, wherein adjacent stator lamination stacks of the at least two stator lamination stacks are in each case spaced parallel to one another in an axial direction and forming in each case one stator cooling duct with a stator cooling duct width through which a cooling medium can be guided; and
a rotor comprising an annularly configured rotor segment including:
a magnet carrier segment having an annular or part-annular geometry and a rotor internal circumferential face, and
a plurality of magnet units which are disposed on the magnet carrier segment at a spacing from one another in a circumferential direction and form or define the rotor internal circumferential face;
wherein, in an axial direction two or a plurality of magnet units of the plurality of magnet units are disposed spaced apart from one another, wherein the magnet units disposed adjacently in the axial direction define a circumferential gap with a gap width for feeding and for distributing a cooling medium; and
generating a flow of a cooling medium through the provided generator; and
guiding the cooling medium through a stator cooling duct of a stator laminated core of a stator segment of the generator provided, in a radial direction; and/or
guiding the cooling medium through a circumferential gap of a rotor segment of the generator provided, between magnet units disposed spaced apart from one another in an axial direction; and/or
guiding the cooling medium through a coil spacing gap of a stator segment of the generator provided, between coil units of the at least one coil unit disposed spaced apart from one another in a circumferential direction, in the radial direction.

15. The method as claimed in claim 14, wherein:
guiding the cooling medium through a stator cooling duct comprises:
guiding the cooling medium through a stator cooling duct which is disposed in an axial direction between first and second carrier plates, from a radially outer stator external circumferential face in the direction of a stator internal circumferential face that in terms of the stator external circumferential face is on the inside;
guiding the cooling medium through a stator cooling duct, which is disposed in an axial direction between a first carrier plate and a first pressure sheet and/or disposed between a second carrier plate and a second pressure sheet, from a radially inner stator internal circumferential face in the direction of a stator external circumferential face that in terms of the stator internal circumferential face is on the outside; and/or
guiding the cooling medium through a circumferential gap comprises:
feeding and distributing the cooling medium from the circumferential gap on the stator laminated core, by way of a stator external circumferential face; and/or
the method furthermore comprises:
diverting and/or dividing the cooling medium supplied from the circumferential gap with a stator guide device by way of a stator external circumferential face, in an axial direction; and/or
feeding the cooling medium to the circumferential gap, through a first feed duct which, proceeding from a first and/or a second pressure sheet of a magnet carrier segment, extends to the circumferential gap; and/or
feeding the cooling medium to the stator external circumferential face in the direction of the circumferential gap through a second feed duct, which, proceeding from a first and/or a second pressure sheet of a magnet carrier segment, extends in the direction of the circumferential gap.

16. The stator segment as claimed in claim 1, wherein the stator is a segmented stator of a segmented generator and the adjacent stator lamination stacks of the at least two stator lamination stacks are in each case spaced parallel to one another in the axial direction and forming in each case one stator cooling duct with a stator cooling duct width through which a cooling medium can be guided in a radial direction.
